(19) United States
(12) Patent Application Publication
(10) Pub. No.: US 2025/0175096 A1
(43) Pub. Date: May 29, 2025

(54) ELECTRIC COMPRESSOR

(71) Applicant: KABUSHIKI KAISHA TOYOTA JIDOSHOKKI, Aichi (JP)

(72) Inventors: Shun ITO, Aichi (JP); Yoshiki NAGATA, Aichi (JP); Takashi KAWASHIMA, Aichi (JP); Hiroshi FUKASAKU, Aichi (JP); Shunsuke AMBO, Aichi (JP); Kazuhiro SHIRAISHI, Aichi (JP)

(73) Assignee: KABUSHIKI KAISHA TOYOTA JIDOSHOKKI, Aichi (JP)

(21) Appl. No.: 18/953,358

(22) Filed: Nov. 20, 2024

(30) Foreign Application Priority Data
Nov. 29, 2023 (JP) 2023-201711

(51) Int. Cl. H02M 7/539; F04C 18/02; F04C 23/02; H02M 1/44; H02P 27/00

(52) U.S. Cl. CPC H02M 7/539; F04C 18/0215; F04C 23/02; H02M 1/44; H02P 27/00; F04C 2240/40; F04C 2270/135

(57) ABSTRACT

An electric compressor includes a compression part, a motor, and an inverter device. The inverter device has an inverter circuit unit and a noise reduction unit that reduces common mode noise and normal mode noise. The noise reduction unit has a common mode choke coil that has a core, a first winding wire, and a second winding wire and reduces the common mode noise, a smoothing capacitor, and a magnetic material damping portion in which an eddy current is induced by a leakage magnetic flux leaked from the core. The magnetic material damping portion reduces the normal mode noise. The noise reduction unit has a plurality of the magnetic material damping portions. The plurality of the magnetic material damping portions are stacked with an insulation layer interposed therebetween.

### CROSS-REFERENCE TO RELATED APPLICATION

This application claims priority to Japanese Patent Application No. 2023-201711 filed on Nov. 29, 2023, the entire disclosure of which is incorporated herein by reference.

### BACKGROUND ART

The present disclosure relates to an electric compressor.

An electric compressor for a vehicle that is mounted on the vehicle such as an electric vehicle is described in Japanese Patent No. 6673468. The electric compressor for the vehicle includes a compression part that compresses fluid, a motor that drives the compression part, and an inverter device that drives the motor. The inverter device includes an inverter circuit unit and a noise reduction unit. The inverter circuit unit converts DC power to AC power. The noise reduction unit is provided on an input side of the inverter circuit unit. The noise reduction unit reduces common mode noise and normal mode noise.

The noise reduction unit has a common mode choke coil, a smoothing capacitor, and a damping portion. The common mode choke coil has a core formed in an annular shape, a first winding wire wound around the core, a second winding wire wound around the core and arranged next to the first winding wire with a distance. The common mode choke coil reduces the common mode noise. The smoothing capacitor forms a low-pass filter circuit together with the common mode choke coil. The damping portion is made of a magnetic material. The damping portion is disposed around the common mode choke coil.

When a normal mode current flows through the first winding wire and the second winding wire, a magnetic flux is leaked from the core. The leakage magnetic flux leaked from the core flows through the damping portion to induce an eddy current in the damping portion. The eddy current induced in the damping portion is converted into thermal energy. This provides a damping effect. The damping portion reduces the normal mode noise.

Against a backdrop of higher power supply voltage along with spread of an electric vehicle, or the like and other factors, a current input to a common mode choke coil (hereinafter, called “input current”) increases. For this reason, it has been required to ensure a damping resistance when a large current is input to the common mode choke coil.

### SUMMARY

In accordance with an aspect of the present disclosure, there is provided an electric compressor that includes a compression part configured to compress fluid, a motor configured to drive the compression part, and an inverter device configured to drive the motor. The inverter device has an inverter circuit unit that converts DC power to AC power and a noise reduction unit that is provided on an input side of the inverter circuit unit and reduces common mode noise and normal mode noise. The noise reduction unit has a common mode choke coil that has a core formed in an annular shape, a first winding wire wound around the core, and a second winding wire wound around the core and arranged next to the first winding wire with a distance, the common mode choke coil reducing the common mode noise, a smoothing capacitor that forms a low-pass filter circuit together with the common mode choke coil, and a magnetic material damping portion that is made of a plate-shaped magnetic material and in which an eddy current is induced by a leakage magnetic flux leaked from the core, the magnetic material damping portion reducing the normal mode noise. The noise reduction unit has a plurality of the magnetic material damping portions. The plurality of the magnetic material damping portions are stacked with an insulation layer interposed between the magnetic material damping portions.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional side view illustrating an electric compressor according to a first embodiment;

FIG. 2 is a circuit diagram illustrating an electrical configuration of the electric compressor;

FIG. 3 is a perspective view illustrating a part of a holder and a magnetic material damping portion;

FIG. 4 is a perspective view illustrating a common mode choke coil;

FIG. 5 at (a) is a front view illustrating a part of the electric compressor according to the first embodiment, and FIG. 5 at (b) is an enlarged view of FIG. 5 at (a);

FIG. 6 is a cross-sectional view illustrating a part of the electric compressor of the first embodiment;

FIG. 7 is a graph showing a relationship between an input current input to the common mode choke coil and a damping resistance;

FIG. 8 is an exploded perspective view illustrating the common mode choke coil and a non-magnetic material damping portion; FIG. 9 at (a) is a front view illustrating a part of an electric compressor according to a second embodiment, and FIG. 9 (b) is an enlarged view of FIG. 9 at (a);

FIG. 10 is a cross-sectional view illustrating a part of the electric compressor of the second embodiment; and

FIG. 11 is a graph showing the relationship between an input current input to a common mode choke coil and a total damping resistance of the magnetic material damping portion and the non-magnetic material damping portion.

### DETAILED DESCRIPTION OF THE EMBODIMENTS

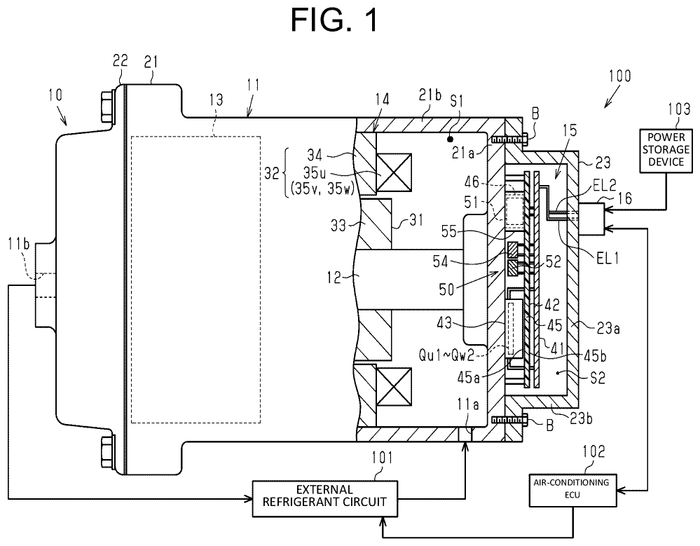

The following will describe a first embodiment of an electric compressor with reference to FIGS. 1 to 7. The electric compressor is mounted on a vehicle such as an electric vehicle. The electric compressor of the first embodiment is used in a vehicle air conditioner.

As illustrated in FIG. 1, a vehicle air conditioner 100 includes an electric compressor 10 and an external refrigerant circuit 101. The external refrigerant circuit 101 supplies a refrigerant as fluid to the electric compressor 10. The external refrigerant circuit 101 has, for example, a heat exchanger, an expansion valve, or the like, which are not illustrated. The vehicle air conditioner 100 performs heating and cooling of a vehicle compartment by the electric compressor 10 that compresses the refrigerant and the external refrigerant circuit 101 through which heat is exchanged from or to the refrigerant and the refrigerant is expanded.

The vehicle air conditioner 100 includes an air-conditioning ECU 102. The air-conditioning ECU 102 controls the entire vehicle air conditioner 100. The air-conditioning ECU 102 is formed so as to obtain a temperature inside the vehicle and a setting temperature of the vehicle air conditioner 100. The air-conditioning ECU 102 sends various commands such as ON/OFF commands to the electric compressor 10, based on parameters such as the temperature inside the vehicle and the setting temperature of the vehicle air conditioner 100.

### Electric Compressor

The electric compressor 10 includes a housing 11, a rotary shaft 12, a compression part 13 that compresses the refrigerant, a motor 14 that drives the compression part 13, and an inverter device 15 that drives the motor 14.

The rotary shaft 12, the compression part 13, the motor 14, and the inverter device 15 are accommodated in the housing 11. The housing 11 is made of metal. The housing 11 in the first embodiment is made of aluminum. The housing 11 is grounded to a body of the vehicle. The housing 11 has a suction housing 21, a discharge housing 22, and an inverter housing 23.

The suction housing 21 has an end wall 21a that is formed in a plate shape and a peripheral wall 21b that is formed in a tubular shape extending from an outer peripheral portion of the end wall 21a. The discharge housing 22 is connected to an end portion of the suction housing 21 at an opening side thereof. The discharge housing 22 closes the opening of the suction housing 21. The suction housing 21 and the discharge housing 22 define a suction chamber S1. The rotary shaft 12, the compression part 13, and the motor 14 are accommodated in the suction chamber S1. The motor 14 is disposed between the compression part 13 and the end wall 21a of the suction housing 21 in the suction chamber S1.

The inverter housing 23 has an end wall 23a that is formed in a plate shape and a peripheral wall 23b that is formed in a tubular shape extending from an outer peripheral portion of the end wall 23a. The inverter housing 23 is connected to the end wall 21a of the suction housing 21 by bolts B. The end wall 21a of the suction housing 21 and the inverter housing 23 define an inverter accommodation chamber S2. The inverter device 15 is accommodated in the inverter accommodation chamber S2.

A connector 16 is attached to the end wall 23a of the inverter housing 23. The connector 16 is electrically connected to a power storage device 103 mounted on the vehicle. The power storage device 103 is a power supply from which a power is supplied to equipment mounted on the vehicle. The power storage device 103 is a DC power supply. The power storage device 103 is, for example, a rechargeable battery or a capacitor.

The housing 11 has a suction port 11a. The suction port 11a is formed in the peripheral wall 21b of the suction housing 21. The suction port 11a is located closer to the end wall 21a than the discharge housing 22 in the peripheral wall 21b of the suction housing 21. The housing 11 also has a discharge port 11b. The discharge port 11b is formed in the discharge housing 22. The suction port 11a is connected to one end of the external refrigerant circuit 101, and the discharge port 11b is connected to the other end of the external refrigerant circuit 101.

The rotary shaft 12 is rotatably supported by the housing 11. An axial direction of the rotary shaft 12 coincides with an axial direction of the peripheral wall 21b of the suction housing 21.

The compression part 13 is connected to the rotary shaft 12. The compression part 13 compresses the refrigerant when the rotary shaft 12 rotates. The compression part 13 is a scroll type compression part that is formed of a fixed scroll fixed to the suction housing 21 and an orbiting scroll disposed so as to face the fixed scroll. Illustrations of the fixed scroll and the orbiting scroll are omitted.

The motor 14 includes a rotor 31 and a stator 32.

The rotor 31 has a rotor core 33 formed in a cylindrical shape and permanent magnets provided in the rotor core 33. Illustrations of the permanent magnets are not illustrated. The rotary shaft 12 is inserted in the rotor core 33. The rotary shaft 12 is fixed to the rotor core 33. The rotary shaft 12 rotates integrally with the rotor 31.

The stator 32 faces the rotor 31 in a radial direction of the rotary shaft 12.

The stator 32 has a stator core 34 formed in a cylindrical shape, a u-phase coil 35u, a v-phase coil 35v, and a w-phase coil 35w. The stator core 34 is fixed to an inner circumferential surface of the peripheral wall 21b of the suction housing 21. The u-phase coil 35u, the v-phase coil 35v, and the w-phase coil 35w are each wound around the stator core 34.

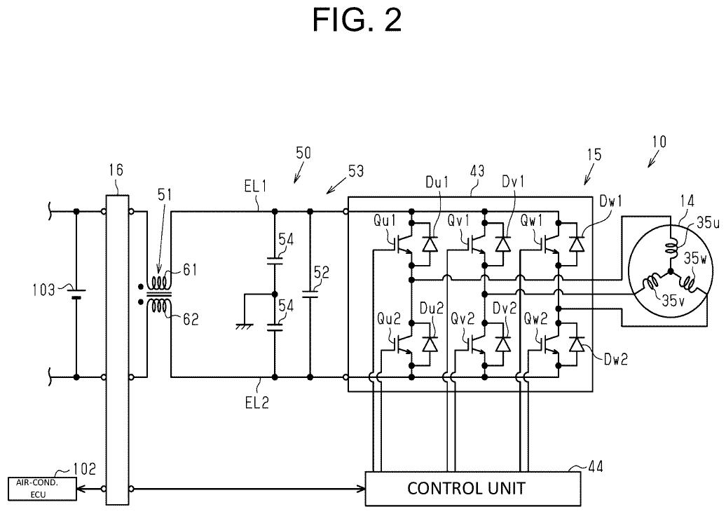

As illustrated in FIG. 2, the u-phase coil 35u, the v-phase coil 35v, and the w-phase coil 35w are connected in Y-connection, for example. An aspect of the connection of the u-phase coil 35u, the v-phase coil 35v, and the w-phase coil 35w is not limited to the Y-connection and may be selected as appropriate. The aspect of the connection of the u-phase coil 35u, the v-phase coil 35v, and the w-phase coil 35w may be connected, for example, in delta-connection.

A current flows through the u-phase coil 35u, the v-phase coil 35v, and the w-phase coil 35w in a predetermined pattern, which rotates the rotor 31. The rotary shaft 12 rotates with the rotation of the rotor 31. This drives the compression part 13. Thus, the motor 14 drives the compression part 13. The compression part 13 compresses the refrigerant sucked into the suction chamber S1 from the external refrigerant circuit 101 through the suction port 11a. The refrigerant compressed by the compression part 13 is discharged to the external refrigerant circuit 101 through the discharge port 11b.

### Inverter Device

As illustrated in FIGS. 1 and 2, the inverter device 15 has a circuit board 41, a holder 42, an inverter circuit unit 43, a control unit 44, and a noise reduction unit 50.

As illustrated in FIG. 1, the circuit board 41 is disposed between the end wall 21a of the suction housing 21 and the end wall 23a of the inverter housing 23 in the axial direction of the rotary shaft 12. A thickness direction of the circuit board 41 coincides with the axial direction of the rotary shaft 12.

The holder 42 is made of resin. The holder 42 is disposed between the circuit board 41 and the end wall 21a of the suction housing 21.

The holder 42 has a main body portion 45 formed in a plate shape. A thickness direction of the main body portion 45 coincides with the axial direction of the rotary shaft 12. The main body portion 45 has a first surface 45a and a second surface 45b. The first surface 45a and the second surface 45b are surfaces perpendicular to the thickness direction of the main body portion 45. The first surface 45a of the main body portion 45 is located so as to face the end wall 21a of the suction housing 21. The second surface 45b of the main body portion 45 is located so as to face the circuit board 41.

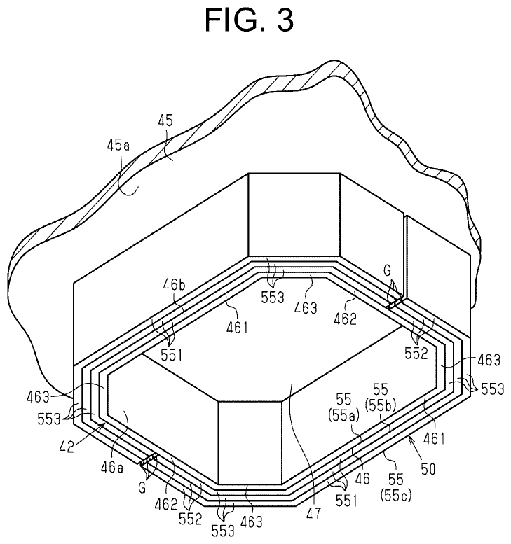

As illustrated in FIG. 3, the holder 42 has a tubular portion 46 provided upright from the first surface 45a of the main body portion 45. The first surface 45a of the main body portion 45 and an inner circumferential surface 46a of the tubular portion 46 define an accommodation space 47.

The tubular portion 46 of the first embodiment is formed in an octagonal tubular shape. The tubular portion 46 has a pair of first wall portions 461, a pair of second wall portions 462, and four third wall portions 463. The pair of first wall portions 461 face each other. The pair of second wall portions 462 face each other in a direction perpendicular to a direction in which the pair of first wall portions 461 face each other. Each of the third wall portions 463 connects the corresponding first wall portion 461 to the corresponding second wall portion 462.

As illustrated in FIG. 1, in the first embodiment, the inverter circuit unit 43 is disposed between the main body portion 45 of the holder 42 and the end wall 21a of the suction housing 21 in the axial direction of the rotary shaft 12. The inverter circuit unit 43 is mounted on the circuit board 41. The inverter circuit unit 43 converts DC power to AC power.

As illustrated in FIG. 2, the inverter circuit unit 43 has two connection lines EL1 and EL2. The inverter circuit unit 43 includes u-phase switching elements Qu1 and Qu2 corresponding to the u-phase coil 35u. The inverter circuit unit 43 has v-phase switching elements Qv1 and Qv2 corresponding to the v-phase coil 35v. The inverter circuit unit 43 has w-phase switching elements Qw1 and Qw2 corresponding to the w-phase coil 35w. Each of the switching elements Qu1 to Qw2 is, for example, a power switching element such as an insulated gate bipolar transistor (IGBT). The switching elements Qu1, Qu2, Qv1, Qv2, Qw1, and Qw2 are connected to freewheeling diodes Du1, Du2, Dv1, Dv2, Dw1, and Dw2, respectively.

The u-phase switching elements Qu1 and Qu2 are connected in series. A node between the u-phase switching elements Qu1 and Qu2 is connected to the u-phase coil 35u. A series connected body of the u-phase switching elements Qu1 and Qu2 are electrically connected to both of the connection lines EL1 and EL2.

The v-phase switching elements Qv1 and Qv2 are connected in series. A node between the v-phase switching elements Qv1 and Qv2 is connected to the v-phase coil 35v. A series connected body of the v-phase switching elements Qv1 and Qv2 are electrically connected to both of the connection lines EL1 and EL2.

The w-phase switching elements Qw1 and Qw2 are connected in series. A node between the w-phase switching elements Qw1 and Qw2 is connected to the w-phase coil 35w. A series connected body of the w-phase switching elements Qw1 and Qw2 are electrically connected to both of the connection lines EL1 and EL2.

The control unit 44 controls the inverter circuit unit 43. The control unit 44 controls switching operation of each of the switching elements Qu1 to Qw2. For example, the control unit 44 is formed of one dedicated hardware circuit or more, and/or one processor (control circuit) or more that is operated in accordance with computer programs (software). The processor includes a CPU and a memory such as a RAM and a ROM. The memory stores the program codes or commands for causing the processor to execute various processes. The memory, that is, a computer readable medium, includes any available medium that is accessible by a general-purpose computer or a dedicated computer.

The control unit 44 is electrically connected to the air-conditioning ECU 102 through the connector 16. The control unit 44 periodically turns each of the switching elements Qu1 to Qw2 on and off in response to commands from the air-conditioning ECU 102. In detail, the control unit 44 performs pulse width modulation control (PWM control) of the switching elements Qu1 to Qw2 in response to the commands from the air-conditioning ECU 102. More specifically, the control unit 44 generates control signals using a carrier signal (carrier wave signal) and command voltage signals (signal to be compared). The control unit 44 performs ON/OFF control of each of the switching elements Qu1 to Qw2 using the generated control signals to convert DC power to AC power.

### Noise reduction Unit

The noise reduction unit 50 is provided on an input side of the inverter circuit unit 43. The noise reduction unit 50 reduces common mode noise and normal mode noise.

As illustrated in FIG. 1, in the first embodiment, the noise reduction unit 50 is disposed between the main body portion 45 of the holder 42 and the end wall 21a of the suction housing 21 in the axial direction of the rotary shaft 12. The noise reduction unit 50 is mounted on the circuit board 41.

As illustrated in FIG. 2, the noise reduction unit 50 includes a common mode choke coil 51 and a smoothing capacitor 52. The smoothing capacitor 52 forms a low-pass filter circuit 53 together with the common mode choke coil 51. The low-pass filter circuit 53 is provided on the connection lines EL1 and EL2. The low-pass filter circuit 53 is provided between the connector 16 and the inverter circuit unit 43 for its circuitry. The common mode choke coil 51 is provided on both of the connection lines EL1 and EL2.

The smoothing capacitor 52 is provided closer to the inverter circuit unit 43 than the common mode choke coil 51 for its circuitry. The smoothing capacitor 52 is an X-capacitor connected in parallel with the inverter circuit unit 43. The smoothing capacitor 52 is electrically connected to both of the connection lines EL1 and EL2. The common mode choke coil 51 and the smoothing capacitor 52 form an LC resonance circuit. Accordingly, the low-pass filter circuit 53 of the first embodiment is the LC resonance circuit including the common mode choke coil 51.

The noise reduction unit 50 has two Y-capacitors 54. The two Y-capacitors 54 are connected in series. A node between the two Y-capacitors 54 is grounded to the body of the vehicle through the housing 11. The two Y-capacitors 54 are provided closer the inverter circuit unit 43 than the common mode choke coil 51 for its circuitry. The two Y capacitors 54 are connected in parallel with the common mode choke coil 51. The two Y capacitors 54 are connected in parallel with the smoothing capacitor 52. That is, the two Y capacitors 54 are provided between the common mode choke coil 51 and the smoothing capacitor 52.

The common mode choke coil 51 suppresses that high frequency noise generated on a vehicle side is transmitted to the inverter circuit unit 43 of the electric compressor 10. The common mode choke coil 51 reduces the common mode noise. A leakage inductance of the common mode choke coil 51 is used as an inductance component in the low-pass filter circuit (LC filter) 53 for removing the normal mode noise (differential mode noise). That is, the common mode choke coil 51 serves for reducing the common mode noise and the normal mode noise (differential mode noise). Accordingly, in the electric compressor 10 of the first embodiment, the common mode noise and the normal mode noise are reduced using the common mode choke coil 51, instead of using a choke coil for a common mode and a choke coil for a normal mode (differential mode).

### Common Mode Choke Coil

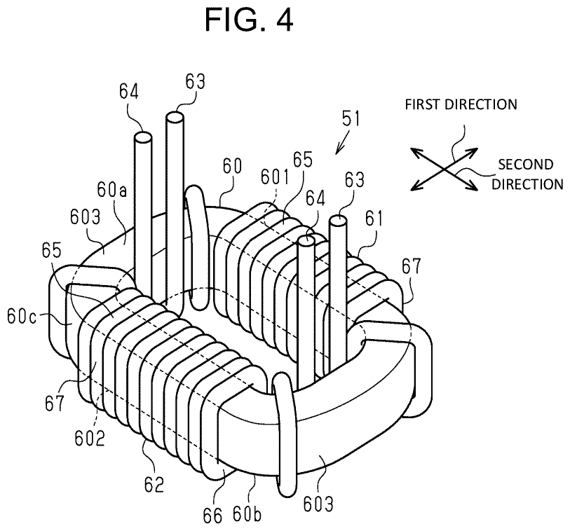

As illustrated in FIG. 4, the common mode choke coil 51 has a core 60, a first winding wire 61, and a second winding wire 62.

The core 60 is formed in an annular shape. The core 60 is made of a ferromagnetic material, for example, a ferrite core. The core 60 has a first wound portion 601, a second wound portion 602, and a pair of connecting portions 603. The first wound portion 601 and the second wound portion 602 each extend linearly. The first wound portion 601 and the second wound portion 602 extend in parallel with each other. One connecting portion 603 connects one end of the first wound portion 601 to one end of the second wound portion 602, and the other connecting portion 603 connects the other end of the first wound portion 601 to the other end of the second wound portion 602. The core 60 has a first end surface 60a and a second end surface 60b. The first end surface 60a is one end surface of the core 60 in an axial direction of the core 60, and the second end surface 60b is the other end surface of the core 60 in the axial direction of the core 60.

The first winding wire 61 is wound around the first wound portion 601 of the core 60. In the first embodiment, a part of the first winding wire 61 is also wound around the pair of connecting portions 603 of the core 60. Both end portions of the first winding wire 61 are drawn from the core 60 over the first end surface 60a of the core 60 as a pair of first lead portions 63.

The second winding wire 62 is wound around the second wound portion 602 of the core 60. In the first embodiment, a part of the second winding wire 62 is also wound around the pair of connecting portions 603 of the core 60. The second winding wire 62 is arranged next to the first winding wire 61 with a distance. In the following description, a direction in which the first winding wire 61 and the second winding wire 62 are arranged is defined as a first direction, and a direction perpendicular to both the axial direction of the core 60 and the first direction is defined as a second direction. Both end portions of the second winding wire 62 are drawn from the core 60 over the first end surface 60a of the core 60 as a pair of second lead portions 64.

Each of the first winding wire 61 and the second winding wire 62 has a first portion 65 located on the first end surface 60a of the core 60, a second portion 66 located on the second end surface 60b of the core 60, and a third portion 67 located on an outer peripheral surface 60c of the core 60.

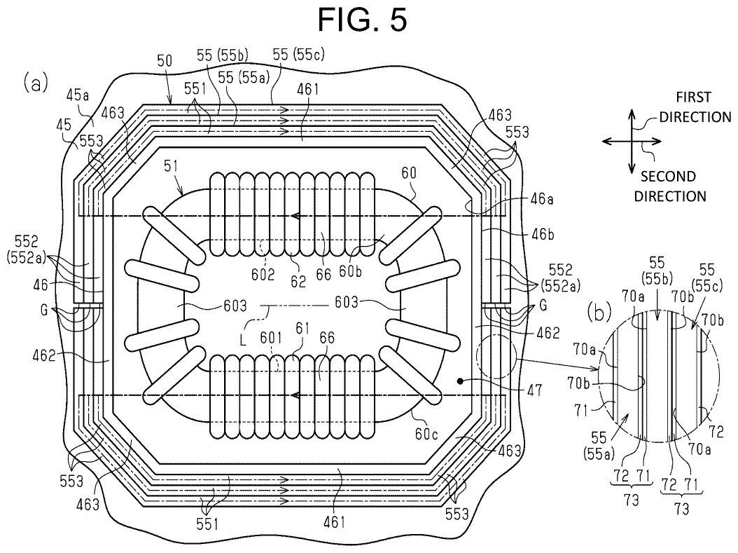

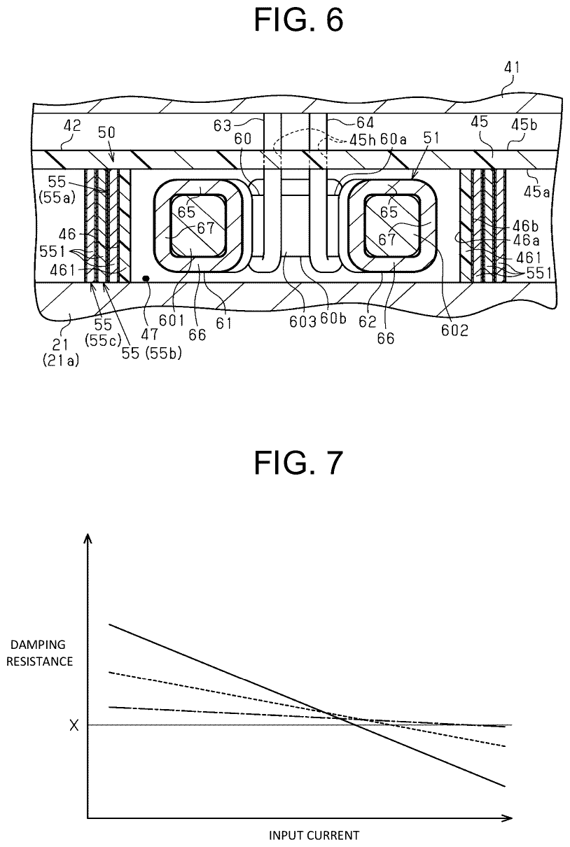

As illustrated in FIGS. 5 at (a) and FIG. 6, the common mode choke coil 51 is accommodated in the accommodation space 47 of the holder 42. The axial direction of the core 60 and the axial direction of the tubular portion 46 coincide with each other. The first end surface 60a of the core 60 is located near the first surface 45a of the main body portion 45. The second end surface 60b of the core 60 is located near the end wall 21a of the suction housing 21.

As illustrated in FIG. 6, the first lead portions 63 and the second lead portions 64 are inserted into insertion holes 45h that extend through the main body portion 45. The first lead portions 63 and the second lead portions 64 are soldered to the circuit board 41, for example. As a result, the first winding wire 61 and the second winding wire 62 are electrically connected to the circuit board 41.

### Magnetic Material Damping Portion

As illustrated in FIG. 3 and FIG. 5 at (a), the noise reduction unit 50 has a plurality of magnetic material damping portions 55 that reduce the normal mode noise. The noise reduction unit 50 of the first embodiment has three magnetic material damping portions 55. In the first embodiment, the three magnetic material damping portions 55 have the same configuration. When the three magnetic material damping portions 55 are distinguished from one another, they are referred to as a first magnetic material damping portion 55a, a second magnetic material damping portion 55b, and a third magnetic material damping portion 55c. The magnetic material damping portions 55 are each made of a plate-shaped conductive magnetic material. The magnetic material damping portions 55 are made of, for example, iron or electromagnetic steel. The magnetic material damping portions 55 are each formed in a plate shape. A thickness of each of the magnetic material damping portions 55 is several hundred micrometer. Here, in the drawings, the thickness of the magnetic material damping portion 55 is exaggerated.

Each of the magnetic material damping portion 55 is disposed outside the tubular portion 46. The first magnetic material damping portion 55a is provided along an outer circumferential surface 46b of the tubular portion 46. The second magnetic material damping portion 55b is provided along an outer peripheral surface of the first magnetic material damping portion 55a. The third magnetic material damping portion 55c is provided along an outer peripheral surface of the second magnetic material damping portion 55b. The three magnetic material damping portions 55 are stacked in a direction perpendicular to the axial direction of the core 60.

Each of the magnetic material damping portions 55 extends in a circumferential direction of the core 60 such that the magnetic material damping portion 55 surrounds an outer periphery of the core 60. Each of the magnetic material damping portion 55 has a pair of first portions 551, a pair of second portions 552, and four third portions 553. The pair of first portions 551 are disposed with the common mode choke coil 51 interposed therebetween in the first direction. The pair of second portions 552 are disposed with the common mode choke coil 51 interposed therebetween in the second direction. The pair of second portions 552 includes a pair of side portions 552a disposed with a space between the first winding wire 61 and the second winding wire 62 interposed between the side portions 552a in the second direction. Each of the third portions 553 connects the corresponding first portion 551 and the corresponding second portion 552.

As illustrated in FIG. 5 at (b), each of the magnetic material damping portions 55 has a first surface 70a and a second surface 70b. The first surface 70a and the second surface 70b are surfaces of each of the magnetic material damping portions 55 that extend perpendicular to a thickness direction of the magnetic material damping portion 55. The first surface 70a corresponds to an inner peripheral surface of the magnetic material damping portion 55. The second surface 70b corresponds to an outer peripheral surface of the magnetic material damping portion 55. In the first embodiment, a first resin layer 71 is provided as a resin layer on the first surface 70a of each of the magnetic material damping portions 55. A second resin layer 72 is provided as the resin layer on the second surface 70b of each of the magnetic material damping portions 55. Note that illustrations of the first resin layers 71 and the second resin layers 72 are omitted in FIG. 3 and FIG. 5 at (a).

The first magnetic material damping portion 55a and the second magnetic material damping portion 55b are insulated by the second resin layer 72 of the first magnetic material damping portion 55a and the first resin layer 71 of the second magnetic material damping portion 55b. That is, the second resin layer 72 of the first magnetic material damping portion 55a and the first resin layer 71 of the second magnetic material damping portion 55b form an insulation layer 73 interposed between the stacked magnetic material damping portions 55.

The second magnetic material damping portion 55b and the third magnetic material damping portion 55c are insulated by the second resin layer 72 of the second magnetic material damping portion 55b and the first resin layer 71 of the third magnetic material damping portion 55c. That is, the second resin layer 72 of the second magnetic material damping portion 55b and the first resin layer 71 of the third magnetic material damping portion 55c form the insulation layer 73 interposed between the stacked magnetic material damping portions 55. Thus, the three magnetic material damping portions 55 are stacked with the insulation layer 73 interposed between the magnetic material damping portions 55.

Each of the magnetic material damping portions 55 of the first embodiment has gap portions G that increase a magnetic reluctance in a direction in which the magnetic material damping portion 55 extends. In the first embodiment, the gap portions G are each formed in a corresponding one of the pair of side portions 552a. Specifically, the gap portions G are formed on an imaginary straight line L that extends in the second direction and located in a middle portion between the first winding wire 61 and the second winding wire 62 in the first direction. The gap portion G of the first magnetic material damping portion 55a, the gap portion G of the second magnetic material damping portion 55b, and the gap portion G of the third magnetic material damping portion 55c are aligned with each other in the second direction.

In the first embodiment, the gap portion G is formed over an entire thickness of each of the magnetic material damping portions 55. In addition, the gap portion G is formed over an entire length of each of the magnetic material damping portions 55 in the axial direction of the core 60. With this configuration, each of the magnetic material damping portions 55 is discontinuous in the direction in which the magnetic material damping portion 55 extends due to the gap portion G. Accordingly, portions of each of the magnetic material damping portions 55, which are located on opposite sides in the first direction across the imaginary straight line L, are not electrically connected to each other.

### Operation in the First Embodiment

The following will describe operation of the first embodiment.

The noise reduction unit 50 has the magnetic material damping portions 55 each made of a plate-shaped magnetic material. In a state where a normal mode current flows through the first winding wire 61 and the second winding wire 62, when the leakage magnetic flux leaked from the core 60 flows through the magnetic material damping portions 55, an eddy current is induced in each of the magnetic material damping portions 55. The eddy current induced in each of the magnetic material damping portions 55 is converted into thermal energy. This provides a damping effect.

FIG. 7 is a graph showing a relationship between an input current input to the common mode choke coil 51 and a damping resistance in a comparative example 1, an example 1-1, and an example 1-2. As the damping resistance increases, the damping effect becomes larger. In FIG. 7, a solid line represents the relationship in the comparative example 1, a dashed line represents the relationship in the example 1-1, and a long dashed short dashed line represents the relationship in the example 1-2.

The comparative example 1, the example 1-1, and the example 1-2 are set under the same conditions except for the number of the stacked magnetic material damping portions 55. In the comparative example 1, the noise reduction unit 50 has one magnetic material damping portion 55. That is, in the comparative example 1, there is no stacked magnetic material damping portion 55. In the example 1-1, the noise reduction unit 50 has two magnetic material damping portions 55 which are stacked with the insulation layer 73 interposed therebetween. In the example 1-2, the noise reduction unit 50 has three magnetic material damping portions 55 which are stacked with the insulation layer 73 interposed between the magnetic material damping portions 55. That is, the example 1-2 corresponds to the first embodiment.

As is obvious from FIG. 7, as the input current input to the common mode choke coil 51 increases, the damping resistance decreases. This tendency is common in the comparative example 1, the example 1-1, and the example 1-2. However, the damping resistance in the example 1-1 and the example 1-2 decreases more gradually than that in the comparative example 1. Furthermore, the damping resistance in the example 1-2 decreases more gradually than that in the example 1-1. That is, as the number of the stacked magnetic material damping portions 55 increases, the damping resistance gradually decreases. In other words, as the number of the stacked magnetic material damping portions 55 increases, the damping resistance tends not to decrease much even when the input current input to the common mode choke coil 51 increases. This is because as the number of the stacked magnetic material damping portions 55 increases, the magnetic material damping portions 55 are difficult to reach magnetic saturation. Accordingly, in the first embodiment in which the plurality of magnetic material damping portions 55 are stacked with the insulation layers 73 between the magnetic material damping portions 55, the damping resistance when a large current is input to the common mode choke coil 51 is easily ensured.

As illustrated in FIG. 7, when a small current is input to the common mode choke coil 51, the damping resistance in each of the example 1-1 and the example 1-2 is smaller than that in the comparative example 1. This is because, as the number of the magnetic material damping portions 55 increases, the leakage inductance of the common mode choke coil 51 increases, which decreases a resonance frequency of the LC resonance circuit. In general, an impedance becomes larger at a higher frequency in a characteristic of a coil. Accordingly, when a small current is input to the common mode choke coil 51, the damping resistance decreases as the number of the stacked magnetic material damping portion 55 increases.

On the other hand, when a large current is input to the common mode choke coil 51, the damping resistance in the example 1-1 and the example 1-2 is larger than that in the comparative example 1. For example, it is assumed that a required damping resistance is X shown in FIG. 7. A current value of the input current when the damping resistance is less than X in the example 1-1 and the example 1-2 is larger than that in the comparative example 1. That is, in the example 1-1 and the example 1-2, even when the input current input to the common mode choke coil 51 is a large current, the required damping resistance is easily ensured.

### Advantageous Effects of the First Embodiment

The following will describe advantageous effects of the first embodiment.

(1-1) In the first embodiment, the three magnetic material damping portions 55 are stacked with the insulation layer 73 interposed between the magnetic material damping portions 55, so that the magnetic material damping portions 55 are difficult to reach magnetic saturation. Accordingly, even when the input current input to the common mode choke coil 51 increases, the damping resistance tends not to decrease much. Thus, the damping resistance when a large current is input to the common mode choke coil 51 is easily ensured.

Note that in a case where only one magnetic material damping portion 55 with a large thickness is used instead of using the plurality of the stacked magnetic material damping portions 55, due to a skin effect, while an eddy current is induced on a surface of the magnetic material damping portion 55, the eddy current is hardly induced inside the magnetic material damping portion 55. For this reason, even when the thickness of the only one magnetic material damping portion 55 is equal to a sum of the thicknesses of the plurality of the stacked magnetic material damping portions 55, the damping effect obtained from the only one magnetic material damping portion 55 is smaller than that obtained from the plurality of the stacked magnetic material damping portions 55 in the first embodiment. In other words, when the plurality of the magnetic material damping portions 55 are stacked with the insulation layer 73 interposed between the magnetic material damping portions 55 as in the first embodiment, an eddy current is effectively induced in each of the magnetic material damping portions 55, so that a larger damping effect is obtained.

(1-2) Each of the magnetic material damping portions 55 of the first embodiment extends in the circumferential direction of the core 60 such that the magnetic material damping portion 55 surrounds the outer periphery of the core 60. In this case, a larger damping effect is obtained.

(1-3) Each of the magnetic material damping portions 55 of the first embodiment has the gap portions G that increase the magnetic reluctance in the direction in which the magnetic material damping portion 55 extends. The leakage magnetic flux leaked from the core 60 more easily flows through a path on which the gap portion G is not formed than a path on which the gap portion G is formed in the magnetic material damping portions 55. Moreover, in the first embodiment, the gap portions G are each formed in the corresponding one of the pair of side portions 552a disposed with the space between the first winding wire 61 and the second winding wire 62 interposed between the side portions 552a in the second direction. With this configuration, as illustrated by the long dashed short dashed arrows in FIG. 5 at (a), the magnetic flux after flowing through the first wound portion 601 of the core 60 and the magnetic flux after flowing through the second wound portion 602 of the core 60 each flow through the magnetic material damping portions 55 without being disrupted by the gap portions G to depict a loop.

(1-4) The insulation layer 73 of the first embodiment corresponds to the first resin layer 71 formed on the first surface 70a and the second resin layer 72 formed on the second surface 70b of each of the magnetic material damping portions 55. Thus, as compared with a case where a gap is provided between the magnetic material damping portions 55 instead of the insulation layer 73, insulation between the magnetic material damping portions 55 is easily ensured.

(1-5) The inverter device 15 of the first embodiment has the holder 42 that is made of resin and has the main body portion 45 formed in the plate shape and the tubular portion 46 provided upright from the main body portion 45. The common mode choke coil 51 is accommodated in the accommodation space 47 that is defined by the main body portion 45 and the tubular portion 46 such that the axial direction of the core 60 coincides with the axial direction of the tubular portion 46. This makes it difficult for the common mode choke coil 51 to be shifted. The magnetic material damping portions 55 of the first embodiment are disposed on the outer periphery of the tubular portion 46 of the holder 42. Accordingly, the magnetic material damping portions 55 are insulated from the common mode choke coil 51 by the tubular portion 46.

### Second Embodiment

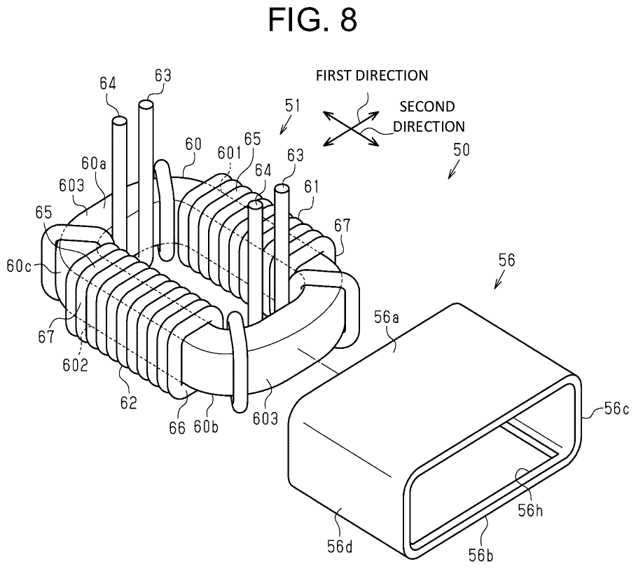

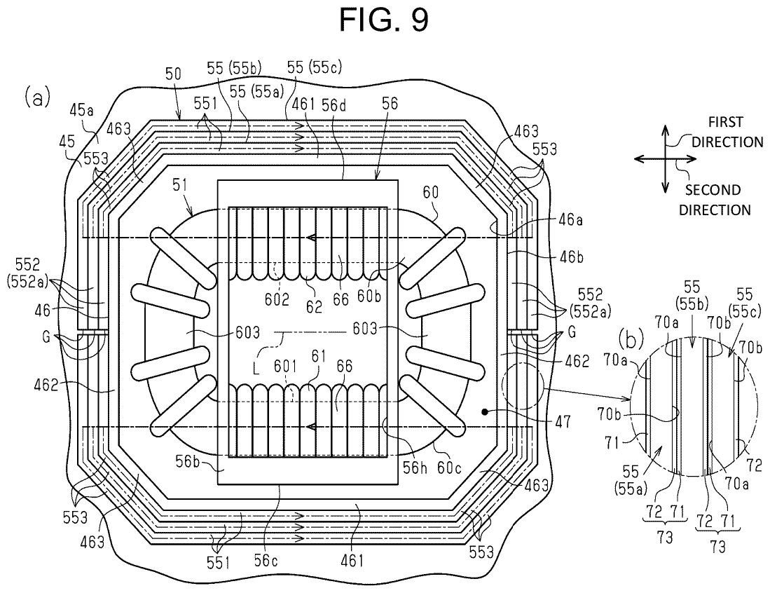

The following will describe a second embodiment of an electric compressor with reference to FIGS. 8 to 11. Note that the second embodiment is different from the first embodiment mainly in that the electric compressor of the second embodiment further has a non-magnetic material damping portion. For this reason, a detailed description of the same configurations as those of the first embodiment will be omitted.

### Non-Magnetic Material Damping Portion

As illustrated in FIG. 8 and FIG. 9 at (a), the noise reduction unit 50 has a non-magnetic material damping portion 56 formed in a plate shape that reduces the normal mode noise. The non-magnetic material damping portion 56 is made of a plate-shaped conductive non-magnetic material. The non-magnetic material damping portion 56 is made of, for example, copper or aluminum.

The non-magnetic material damping portion 56 of the second embodiment is formed in an annular shape. The non-magnetic material damping portion 56 has a first covering portion 56a, a second covering portion 56b, a third covering portion 56c, and a fourth covering portion 56d. The first covering portion 56a, the second covering portion 56b, the third covering portion 56c, and the fourth covering portion 56d are each formed in a rectangular flat plate shape. The first covering portion 56a and the second covering portion 56b are parallel with each other. The second covering portion 56b has a through hole 56h. The through hole 56h extends through the second covering portion 56b in a thickness direction thereof. The third covering portion 56c connects one end portion of the first covering portion 56a in a longitudinal direction thereof to one end portion of the second covering portion 56b in a longitudinal direction thereof. The fourth covering portion 56d connects the other end portion of the first covering portion 56a in the longitudinal direction thereof to the other end portion of the second covering portion 56b in the longitudinal direction thereof. The third covering portion 56c and the fourth covering portion 56d are parallel with each other.

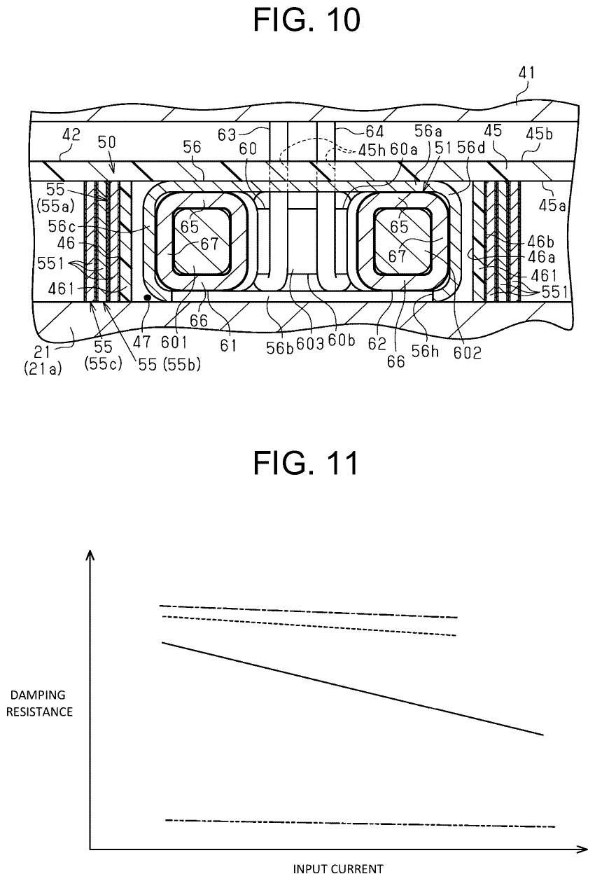

As illustrated in FIG. 9 at (a) and FIG. 10, the non-magnetic material damping portion 56 is accommodated in the accommodation space 47 of the holder 42 together with the common mode choke coil 51. A portion of the common mode choke coil 51 is disposed inside the non-magnetic material damping portion 56. An axial direction of the non-magnetic material damping portion 56 coincides with the second direction. The first wound portion 601 and the second wound portion 602 of the core 60, a portion of the first winding wire 61 wound around the first wound portion 601, and a portion of the second winding wire 62 wound around the second wound portion 602 are located inside the non-magnetic material damping portion 56. The pair of connecting portions 603 of the core 60, a portion of the first winding wire 61 wound around each of the connecting portions 603, and a portion of the second winding wire 62 wound around each of the connecting portions 603 are located outside the non-magnetic material damping portion 56. The pair of first lead portions 63 and the pair of second lead portions 64 are each located on opposite sides of the non-magnetic material damping portion 56 in the axial direction thereof.

The first covering portion 56a and the second covering portion 56b are disposed with the common mode choke coil 51 interposed therebetween in the axial direction of the core 60. The first covering portion 56a is located so as to face the first end surface 60a of the core 60. The second covering portion 56b is located so as to face the second end surface 60b of the core 60. The first covering portion 56a covers the first portion 65 of the first winding wire 61 and the first portion 65 of the second winding wire 62. The second covering portion 56b covers the second portion 66 of the first winding wire 61 and the second portion 66 of the second winding wire 62. The third covering portion 56c and the fourth covering portion 56d are disposed with the common mode choke coil 51 interposed therebetween in the first direction. The third covering portion 56c covers the third portion 67 of the first winding wire 61. The fourth covering portion 56d covers the third portion 67 of the second winding wire 62. As described above, the non-magnetic material damping portion 56 surrounds the first winding wire 61 and the second winding wire 62. The non-magnetic material damping portion 56 covers the first portions 65, the second portions 66, and the third portions 67 of the first winding wire 61 and the second winding wire 62.

As illustrated in FIG. 10, one surface opposite the other surface of the first covering portion 56a facing the common mode choke coil 51 faces the first surface 45a of the main body portion 45 of the holder 42. A heat dissipation grease, which is not illustrated, is applied between one surface opposite the other surface of the second covering portion 56b facing the common mode choke coil 51 and an outer surface of the end wall 21a of the suction housing 21. One surface opposite the other surface of the third covering portion 56c facing the common mode choke coil 51 and one surface opposite the other surface of the fourth covering portion 56d facing the common mode choke coil 51 each face a corresponding one of inner surfaces of the pair of the first wall portions 461 of the tubular portion 46.

As illustrated in FIG. 9 at (a) and at (b), the three magnetic material damping portions 55 are stacked with the insulation layer 73 interposed between the magnetic material damping portions 55. Similarly to the first embodiment, illustrations of the insulation layers 73 are omitted in FIG. 9 at (a).

The plurality of the magnetic material damping portions 55 are disposed outside the first winding wire 61 and the second winding wire 62 of the common mode choke coil 51 across the non-magnetic material damping portion 56. In the second embodiment, the first portion 551 of each of the magnetic material damping portions 55 on one side thereof in the first direction is disposed opposite to the first winding wire 61 and the second winding wire 62 across the third covering portion 56c of the non-magnetic material damping portion 56. The first portion 551 of each of the magnetic material damping portions 55 on the other side thereof in the first direction is disposed opposite to the first winding wire 61 and the second winding wire 62 across the fourth covering portion 56d of the non-magnetic material damping portion 56.

### Operation in the Second Embodiment

The following will describe operation of the second embodiment.

The noise reduction unit 50 has the non-magnetic material damping portion 56 made of the plate-shaped non-magnetic material. The non-magnetic material damping portion 56 surrounds the first winding wire 61 and the second winding wire 62. Accordingly, an induced current generating a magnetic flux that opposes change of the leakage magnetic flux leaked from the core 60 flows through the non-magnetic material damping portion 56. Then, the induced current flowing through the non-magnetic material damping portion 56 is converted into thermal energy. This also provides a damping effect.

FIG. 11 is a graph showing a relationship between an input current input to the common mode choke coil 51 and a damping resistance in a comparative example 2-1, a comparative example 2-2, an example 2-1, and an example 2-2. In FIG. 11, a long dashed double short dashed line represents the relationship in the comparative example 2-1, a solid line represents the relationship in the comparative example 2-2, a dashed line represents the relationship in the example 2-1, and a long dashed short dashed line represents the relationship in the example 2-2.

The comparative example 2-1, the comparative example 2-2, the example 2-1, and the example 2-2 are set under the same conditions except for the number of the stacked magnetic material damping portions 55. In the comparative example 2-1, the comparative example 2-2, the example 2-1, and the example 2-2, the noise reduction unit 50 has the non-magnetic material damping portion 56. In the comparative example 2-1, the noise reduction unit 50 does not have the magnetic material damping portion 55. In the comparative example 2-2, the noise reduction unit 50 has one magnetic material damping portion 55. That is, in the comparative example 2-1 and the comparative example 2-2, there is no stacked magnetic material damping portion 55. In the example 2-1, the noise reduction unit 50 has two magnetic material damping portions 55 which are stacked with the insulation layer 73 interposed therebetween. In the example 2-2, the noise reduction unit 50 has three magnetic material damping portions 55 which are stacked with the insulation layer 73 interposed between the magnetic material damping portions 55. That is, the example 2-2 corresponds to the second embodiment.

As is obvious from FIG. 11, the damping resistance in the comparative example 2-2, the example 2-1, and the example 2-2 is larger than that in the comparative example 2-1. That is, the damping resistance increases in a case where the noise reduction unit 50 has both the magnetic material damping portion 55 and the non-magnetic material damping portion 56 as compared with in a case where the noise reduction unit 50 has only the non-magnetic material damping portion 56.

The damping resistance in the example 2-1 and the example 2-2 decreases more gradually than that in the comparative example 2-2. That is, similarly to the first embodiment, as the number of the magnetic material damping portions 55 increases, the damping resistance decreases more gradually. In other words, as the number of the stacked magnetic material damping portions 55 increases, the damping resistance tends not to decrease much even when the input current input to the common mode choke coil 51 increases. Accordingly, in the second embodiment in which the plurality of magnetic material damping portions 55 are stacked with the insulation layers 73 interposed between the magnetic material damping portions 55, the damping resistance when a large current is input to the common mode choke coil 51 is easily ensured.

In addition, not depending on magnitude of the input current, the damping resistance in the example 2-1 and the example 2-2 is larger than that in the comparative example 2-2. Moreover, not depending on the magnitude of the input current, the damping resistance in the example 2-2 is larger than that in the example 2-1. That is, unlike the first embodiment, in a case where the noise reduction unit 50 has the non-magnetic material damping portion 56, the damping resistance increases as the number of the magnetic material damping portions 55 increases. This is because the leakage magnetic flux leaked from the core 60 increases as the number of the magnetic material damping portions 55 increase, which increases the induced current flowing through the non-magnetic material damping portion 56. Accordingly, in the second embodiment in which the noise reduction unit 50 has the non-magnetic material damping portion 56, the damping resistance when a small current is input to the common mode choke coil 51 increases.

### Advantageous Effects of the Second Embodiment

The following will describe advantageous effects of the second embodiment. The second embodiment provides the following advantageous effects in addition to the advantageous effects (1-1) to (1-5) of the first embodiment.

(2-1) The noise reduction unit 50 of the second embodiment has the non-magnetic material damping portion 56 made of a non-magnetic material. The non-magnetic material damping portion 56 surrounds the first winding wire 61 and the second winding wire 62. With this configuration, an induced current generating a magnetic flux that opposes change of the leakage magnetic flux leaked from the core 60 flows through the non-magnetic material damping portion 56. Then, the induced current flowing through the non-magnetic material damping portion 56 is converted into thermal energy. This also provides a damping effect.

Furthermore, the noise reduction unit 50 has the plurality of magnetic material damping portions 55. With this configuration, leakage magnetic flux increases as compared with the case where the noise reduction unit 50 has one magnetic material damping portion 55, which increases the induced current flowing through the non-magnetic material damping portion 56. Accordingly, the damping resistance when a small current is input to the common mode choke coil 51 increases.

(2-2) For example, when the magnetic material damping portions 55 are disposed between the first winding wire 61 and the non-magnetic material damping portion 56 and between the second winding wire 62 and the non-magnetic material damping portion 56, the leakage magnetic flux leaked from the core 60 branches into a leakage magnetic flux flowing through the magnetic material damping portions 55 inside the non-magnetic material damping portion 56 to depict a loop and a leakage magnetic flux flowing through an outside of the non-magnetic material damping portion 56 to depict a loop. Then, because of the leakage magnetic flux flowing through the magnetic material damping portions 55, the leakage magnetic flux passing through a cross-section of the through hole 56h of the non-magnetic material damping portion 56 decreases, so that the induced current flowing through the non-magnetic material damping portion 56 decreases. As a result, the damping effect obtained from the non-magnetic material damping portion 56 decreases.

On the other hand, in the second embodiment, the plurality of the magnetic material damping portions 55 are disposed outside the first winding wire 61 and the second winding wire 62 across the non-magnetic material damping portion 56. In this case, the leakage magnetic flux passing through the cross-section of the through hole 56h of the non-magnetic material damping portion 56 does not decrease due to the leakage magnetic flux flowing through the magnetic material damping portions 55, so that the induced current flowing through the non-magnetic material damping portion 56 does not decrease. Accordingly, the damping effect obtained from the non-magnetic material damping portion 56 is prevented from decreasing.

(2-3) The non-magnetic material damping portion 56 is accommodated in the accommodation space 47 of the holder 42 together with the common mode choke coil 51. This makes it difficult for the non-magnetic material damping portion 56 to be shifted. The magnetic material damping portions 55 of the second embodiment are disposed on the outer periphery of the tubular portion 46 of the holder 42. Thus, the tubular portion 46 insulates the magnetic material damping portions 55 not only from the common mode choke coil 51 but also from the non-magnetic material damping portion 56.

### Modification

The above-described embodiments may be modified as follows. The above-described embodiments and the following modifications may be combined with each other as long as they do not technically contradict with each other.

The inverter device 15 need not have the holder 42.

The tubular portion 46 of the holder 42 need not be formed in the octagonal tubular shape, as long as the tubular portion 46 is formed in a tubular shape.

The number of magnetic material damping portions 55 stacked with the insulation layer 73 interposed between the magnetic material damping portions 55 is not limited to three. The number of magnetic material damping portions 55 stacked with the insulation layer 73 interposed between the magnetic material damping portions 55 may be two or four or more.

When an eddy current is generated in each of the magnetic material damping portions 55 by the leakage magnetic flux leaked from the core 60, a shape of each of the magnetic material damping portions 55 and positions of the magnetic material damping portions 55 with respect to the common mode choke coil 51 may be changed as appropriate. Here, the plurality of magnetic material damping portions 55 need to be stacked with the insulation layer 73 interposed between the magnetic material damping portions 55.

Each of the magnetic material damping portions 55 may be formed in a flat plate shape, an L-shape, or a U-shape, for example.

For example, the magnetic material damping portions 55 may be disposed so as to cover only the third portion 67 of the first winding wire 61 or may be disposed with the common mode choke coil 51 interposed therebetween in the axial direction of the core 60.

The shape of each of the magnetic material damping portions 55 and the positions of the magnetic material damping portions 55 with respect to the common mode choke coil 51 need not be the same for all of the magnetic material damping portions 55. The shape of each of the magnetic material damping portions 55 and the positions of the magnetic material damping portions 55 with respect to the common mode choke coil 51 may differ for each of the magnetic material damping portions 55. Here, the plurality of magnetic material damping portions 55 need to be stacked with the insulation layer 73 interposed between the magnetic material damping portions 55. The entire portion of one magnetic material damping portion 55 and a portion of another magnetic material damping portion 55 may be stacked with the insulation layer 73 interposed therebetween, or a portion of one magnetic material damping portion 55 and a portion of another magnetic material damping portions 55 may be stacked with the insulation layer 73 interposed therebetween.

In the above-described embodiments, the insulation layer 73 corresponds to the first resin layer 71 provided on the first surface 70a of each of the magnetic material damping portions 55 and the second resin layer 72 provided on the second surface 70b of each of the magnetic material damping portions 55; however, the present disclosure is not limited to this. Any member may be used as the insulation layer 73, as long as the member is interposed between the magnetic material damping portions 55 to insulate them.

As one example, instead of the insulation layer 73, a space may be formed between the magnetic material damping portions 55.

As another example, instead of the insulation layer 73, a member that has insulation property and is separately provided from the magnetic material damping portions 55 may be formed between the magnetic material damping portions 55.

In the above-described embodiments, the resin layers are provided on the opposite surfaces of each of the magnetic material damping portion 55; however, the resin layer may be provided on only one side of each of the magnetic material damping portions 55.

For example, the first resin layer 71 may be provided on the first surface 70a of each of the magnetic material damping portions 55, and the second resin layer 72 need not be provided on the second surface 70b of each of the magnetic material damping portions 55. In this case, the insulation layer 73 is formed of only the first resin layer 71.

For example, the second resin layer 72 may be provided on the second surface 70b of each magnetic material damping portions 55, and the first resin layer 71 need not be provided on the first surface 70a of each of the magnetic material damping portions 55. In this case, the insulation layer 73 is formed of only the second resin layer 72.

In the above-described embodiments, the gap portions G are formed in all of the three magnetic material damping portions 55; however, the present disclosure is not limited to this.

The gap portion G may be formed in at least one of the magnetic material damping portions 55 stacked with the insulation layer 73 interposed between the magnetic material damping portions 55. The phrase “at least one”, which is used in the present specification, means “one or more” of the desired options. As one example, the phrase “at least one”, which is used in the present specification, means, when there is two options, “only one option” or “both of the two options”. As another example, the phrase “at least one”, which is used in the present specification, means, when there is three or more options, “only one of the options” or “any combination of two options or more”.

The gap portions G need not be formed in all of the magnetic material damping portions 55 stacked with the insulation layer 73 interposed between the magnetic material damping portions 55.

In the above-described embodiments, the gap portions G are formed on both of the pair of side portions 552a in each of the magnetic material damping portions 55; however, the gap portions G may be formed on only one of the side portions 552a. As long as the gap portions G are formed in at least one of the pair of side portions 552a, the effect (1-3) of the first embodiment is obtained. Note that “at least one of the pair of side portions 552a” means “only one of the side portions 552a”, “only the other of the side portions 552a”, or “both of the side portions 552a”.

In the above-described embodiments, the gap portions G are formed on the imaginary straight line L; however, the gap portions G may be located in a position which is shifted from the imaginary straight line L in the first direction.

In the above-described embodiments, the gap portions G are formed in the side portions 552a of each of the magnetic material damping portions 55; however, the gap portions G may be formed in the first portions 551 or the third portions 553 other than the side portions 552a of the second portions 552.

The positions of the gap portions G of the magnetic material damping portions 55 need not be the same for all of the magnetic material damping portions 55. The positions of the gap portions G of the magnetic material damping portions 55 may be different for each of the magnetic material damping portions 55, for example.

In the above-described embodiments, the gap portions G are each formed over the entire thickness of the corresponding magnetic material damping portion 55; however, the present disclosure is not limited to this. The gap portions G may be each formed in a portion of the corresponding magnetic material damping portion 55 in the thickness direction thereof.

In the above-described embodiments, the gap portions G are each formed over the entire length of the corresponding magnetic material damping portion 55 in the axial direction of the core 60; however, the present disclosure is not limited to this. The gap portions G may be formed in a portion of the corresponding magnetic material damping portion 55 in the axial direction of the core 60.

The plurality of magnetic material damping portions 55 may be disposed inside the tubular portion 46. In this case, insulation between the magnetic material damping portions 55 and the common mode choke coil 51 needs to be ensured. Examples of methods for ensuring the insulation include a method for ensuring an insulation distance between the magnetic material damping portion 55 and the common mode choke coil 51 and a method for performing an insulating treatment on the surface of the magnetic material damping portion 55, which faces the common mode choke coil 51. In the case where the magnetic material damping portions 55 are disposed inside the tubular portion 46 in the second embodiment, insulation between the magnetic material damping portions 55 and the non-magnetic material damping portion 56 needs to be ensured in addition to the insulation between the magnetic material damping portions 55 and the common mode choke coil 51.

In this case, insulation between the magnetic material damping portions 55 and the other electronic components that are mounted on the circuit board 41 and located outside the tubular portion 46 is ensured by the tubular portion 46. Furthermore, as compared with the case where the magnetic material damping portions 55 are disposed outside the tubular portion 46, the magnetic material damping portions 55 are made closer to the core 60, so that a larger damping effect is obtained.

All of the magnetic material damping portions 55 need not be disposed outside or inside the tubular portion 46.

For example, one of two magnetic material damping portions 55 may be disposed outside the tubular portion 46 and the other of the two magnetic material damping portions 55 may be disposed inside the tubular portion 46. In this case, the tubular portion 46 serves as the insulation layer 73 that insulates the one of the magnetic material damping portions 55 from the other of the magnetic material damping portions 55.

As long as the core 60 is formed in an annular shape, the shape of the core 60 may be changed as appropriate. The core 60 may be, for example, formed in a circular annular shape.

In the above-described embodiments, the core 60 is formed of one part; however, the core 60 may be formed of two parts or more.

As long as the non-magnetic material damping portion 56 surrounds the first winding wire 61 and the second winding wire 62, the shape of the non-magnetic material damping portion 56 may be changed as appropriate. The non-magnetic material damping portion 56 may be, for example, formed in a circular annular shape.

In the above-described embodiments, the non-magnetic material damping portion 56 may be formed of one part; however, the non-magnetic material damping portion 56 may be formed of two parts or more.

The noise reduction unit 50 may have a plurality of common mode choke coils 51. In the second embodiment, the noise reduction unit 50 may have the non-magnetic material damping portion 56 of the same number as that of the common mode choke coil 51.

The compression part 13 is not limited to a scroll type compression part. For example, the compression part 13 may be a piston type compression part or a vane type compression part.

The electric compressor 10 may be mounted on a fuel cell vehicle. In this case, the electric compressor 10 may be an electric compressor in which air as fluid supplied to a fuel cell is compressed by the compression part 13.

### Supplementary Notes

The following will describe technical ideas obtained from the above-described embodiments and the modifications.

### <Supplementary Note 1>

An electric compressor including:
a compression part configured to compress fluid;
a motor configured to drive the compression part; and
an inverter device configured to drive the motor,
the inverter device having:
   an inverter circuit unit that converts DC power to AC power; and
   a noise reduction unit that is provided on an input side of the inverter circuit unit and reduces common mode noise and normal mode noise, and
the noise reduction unit having:
   a common mode choke coil that has a core formed in an annular shape, a first winding wire wound around the core, and a second winding wire wound around the core and arranged next to the first winding wire with a distance, the common mode choke coil reducing the common mode noise;
   a smoothing capacitor that forms a low-pass filter circuit together with the common mode choke coil; and
   a magnetic material damping portion that is made of a plate-shaped magnetic material and in which an eddy current is induced by a leakage magnetic flux leaked from the core, the magnetic material damping portion reducing the normal mode noise, characterized in that
the noise reduction unit has a plurality of the magnetic material damping portions, and
the plurality of the magnetic material damping portions are stacked with an insulation layer interposed between the magnetic material damping portions.

### <Supplementary Note 2>

The electric compressor according to supplementary note 1, characterized in that
the plurality of the magnetic material damping portions each extend in a circumferential direction of the core such that the magnetic material damping portion surrounds an outer periphery of the core.

### <Supplementary Note 3>

The electric compressor according to supplementary note 1, characterized in that
the noise reduction unit has a non-magnetic material damping portion that is made of a plate-shaped non-magnetic material and disposed such that the non-magnetic material damping portion surrounds the first winding wire and the second winding wire and through which an induced current flows, the non-magnetic material damping portion reducing the normal mode noise, the induced current generating a magnetic flux that opposes change of the leakage magnetic flux leaked from the core, and
the plurality of the magnetic material damping portions are each disposed outside the first winding wire and the second winding wire across the non-magnetic material damping portion, the magnetic material damping portion extending in a circumferential direction of the core such that the magnetic material damping portion surrounds an outer periphery of the core.

### <Supplementary Note 4>

The electric compressor according to supplementary note 2 or 3, characterized in that
a direction in which the first winding wire and the second winding wire are arranged is defined as a first direction and a direction perpendicular to both an axial direction of the core and the first direction is defined as a second direction,
the plurality of the magnetic material damping portions each include a pair of side portions disposed with a space between the first winding wire and the second winding wire interposed between the side portions in the second direction, and
at least one of the plurality of the magnetic material damping portions has a gap portion in at least one of the side portions, the gap portion increasing a magnetic reluctance in a direction in which the magnetic material damping portion extends.

### <Supplementary Note 5>

The electric compressor according to any one of supplementary notes 1 to 4, characterized in that
the insulation layer is a resin layer provided on a surface of each of the magnetic material damping portions.

What is claimed is:

1. An electric compressor comprising:
a compression part configured to compress fluid;
a motor configured to drive the compression part; and
an inverter device configured to drive the motor,
the inverter device having:
an inverter circuit unit that converts DC power to AC power; and
a noise reduction unit that is provided on an input side of the inverter circuit unit and reduces common mode noise and normal mode noise, and
the noise reduction unit having:
a common mode choke coil that has a core formed in an annular shape, a first winding wire wound around the core, and a second winding wire wound around the core and arranged next to the first winding wire with a distance, the common mode choke coil reducing the common mode noise;
a smoothing capacitor that forms a low-pass filter circuit together with the common mode choke coil; and
a magnetic material damping portion that is made of a plate-shaped magnetic material and in which an eddy current is induced by a leakage magnetic flux leaked from the core, the magnetic material damping portion reducing the normal mode noise, wherein
the noise reduction unit has a plurality of the magnetic material damping portions, and
the plurality of the magnetic material damping portions are stacked with an insulation layer interposed between the magnetic material damping portions.

2. The electric compressor according to claim 1, wherein
the plurality of the magnetic material damping portions each extend in a circumferential direction of the core such that the magnetic material damping portion surrounds an outer periphery of the core.

3. The electric compressor according to claim 1, wherein
the noise reduction unit has a non-magnetic material damping portion that is made of a plate-shaped non-magnetic material and disposed such that the non-magnetic material damping portion surrounds the first winding wire and the second winding wire and through which an induced current flows, the non-magnetic material damping portion reducing the normal mode noise, the induced current generating a magnetic flux that opposes change of the leakage magnetic flux leaked from the core, and
the plurality of the magnetic material damping portions are each disposed outside the first winding wire and the second winding wire across the non-magnetic material damping portion, the magnetic material damping portion extending in a circumferential direction of the core such that the magnetic material damping portion surrounds an outer periphery of the core.

4. The electric compressor according to claim 2, wherein
a direction in which the first winding wire and the second winding wire are arranged is defined as a first direction and a direction perpendicular to both an axial direction of the core and the first direction is defined as a second direction,
the plurality of the magnetic material damping portions each include a pair of side portions disposed with a space between the first winding wire and the second winding wire interposed between the side portions in the second direction, and
at least one of the plurality of the magnetic material damping portions has a gap portion in at least one of the side portions, the gap portion increasing a magnetic reluctance in a direction in which the magnetic material damping portion extends.

5. The electric compressor according to claim 1, wherein
the insulation layer is a resin layer provided on a surface of each of the magnetic material damping portions.
